(19) United States
(12) Patent Application Publication
(10) Pub. No.: US 2025/0136193 A1
(43) Pub. Date: May 1, 2025

(54) Tailgate Collision Avoidance

(71) Applicant: Rajuan Kquile Yancy, Jacksonville, FL (US)

(72) Inventor: Rajuan Kquile Yancy, Jacksonville, FL (US)

(21) Appl. No.: 18/933,873

(22) Filed: Oct. 31, 2024

Related U.S. Application Data
(60) Provisional application No. 63/594,852, filed on Oct. 31, 2023.

(51) Int. Cl. B62D 33/027; B60R 21/0134

(52) U.S. Cl. CPC B62D 33/0273; B60R 21/0134; B60Y 2400/3015

(57) ABSTRACT

A vehicle tailgate device is disclosed, enhancing safety and functionality. It features a tailgate body with a sensor array and camera system, potentially housed in recessed areas. The sensor array includes radar and ultrasonic sensors, while the control unit has movement detectors to monitor the tailgate's opening and closing. When extended, the sensors emit radar waves. The camera system connects to an in-vehicle display for real-time feedback. The control unit interfaces with notification lights, sound speakers, and a warning display to alert the driver. Additionally, it can connect to an automatic braking mechanism to stop the vehicle if the driver does not respond promptly to warnings, thereby improving overall vehicular safety.

### FIELD OF THE INVENTION

The present invention relates to a transport device. More specifically, the present invention is an improved tailgate with a collision avoidance system configured to safely installed in a vehicle.

### BACKGROUND OF THE INVENTION

The demand for an improved tailgate equipped with a collision avoidance system that can be safely installed in a vehicle is increasing. A tailgate is a board or gate located at the rear of a vehicle, which can be configured to be removed or lowered. Commonly found on passenger vehicles, tailgates are installed at the rear end of the vehicle and can be part of a compartment, such as the rear door on a station wagon or minivan, or at the end of a cargo compartment, such as the bed of a pickup truck.

Modern passenger vehicles serve multiple purposes beyond transportation. For instance, the rear end of a vehicle is often used to support social activities, such as tailgating, which involves using the tailgate as a platform for food and entertainment.

There is a variety of tailgates available today. Pickup trucks often feature tailgates pivotally mounted to the truck bed on a horizontal axis. Some tailgates include a retractable window, and certain station wagons have tailgates that pivot on both vertical and horizontal axes, allowing them to function as either a door or an extended horizontal surface.

Despite these advancements, current tailgates present several challenges. Notably, if a tailgate is opened without adequate clearance from obstacles like parked vehicles or walls, it may result in a collision. This issue is particularly prevalent in crowded parking lots or confined spaces.

Therefore, there is a pressing need to develop a system and method capable of preventing collisions between a tailgate and obstacles by accurately recognizing the position of the tailgate and nearby objects. Such a system would enhance safety and functionality, addressing the limitations of current tailgate designs.

The present invention is intended to solve the problems associated with conventional systems and methods and provide improvements on these systems and methods.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A vehicle tailgate device is disclosed, comprising a tailgate body, a sensor array, a camera system, and a control unit.

In one embodiment, the tailgate body may include one or more recessed areas for accommodating the sensor array and camera system. The sensor array comprises radar and ultrasonic sensors, configured to emit radar waves upon the extension of the tailgate body. In one embodiment, the control unit may incorporate movement detectors to monitor the opening and closing of the tailgate body. The camera system is operatively connected to a display within the vehicle, providing real-time visual feedback to the driver. In one embodiment, the control unit can be further connected to notification lights, sound speakers, and a warning display to deliver alerts. Additionally, the control unit can be configured to interface with an automatic braking mechanism, enabling the vehicle to halt if the driver fails to respond promptly to warnings, thereby enhancing vehicular safety and operational efficiency.

### BRIEF DESCRIPTION OF THE DRAWINGS

FIG. 1 is an illustration of one embodiment of the present invention.

FIG. 2 is an illustration depicting one embodiment of the present invention, featuring various notification units such as lights, speakers, and a display.

FIG. 3 is an illustration showing one embodiment of the present invention with a vehicle where the tailgate body of the present invention can be installed.

### DETAIL DESCRIPTIONS OF THE INVENTION

All illustrations of the drawings are for the purpose of describing selected versions of the present invention and are not intended to limit the scope of the present invention.

As a preliminary matter, it is readily understood by those skilled in the relevant field that the present disclosure possesses broad utility and application. Any embodiment may incorporate one or multiple aspects of the disclosed invention and may further include one or several features described herein. Embodiments identified as “preferred” are considered part of the best mode for implementing the present invention. Other embodiments may be discussed for illustrative purposes to provide a comprehensive and enabling disclosure. Many adaptations, variations, modifications, and equivalent arrangements are implicitly disclosed by the described embodiments and fall within the scope of this invention.

While detailed embodiments are described herein, it is understood that this disclosure is illustrative and exemplary, intended to provide a full and enabling disclosure. The detailed description of one or more embodiments is not intended to limit the scope of patent protection, which is defined by the claims and their equivalents. The scope of patent protection is not defined by reading into any claim limitations not explicitly stated in the claim itself.

For example, any sequence or temporal order of steps in various processes or methods described herein is illustrative and not restrictive. Steps of such processes or methods are not limited to any particular sequence or order unless otherwise indicated. Steps may be carried out in different sequences and orders while still falling within the scope of the present disclosure. The scope of patent protection is defined by the issued claims rather than the description herein.

Each term used herein refers to what an ordinary artisan would understand based on the contextual use of the term. If the meaning of a term differs from a dictionary definition, the meaning understood by the ordinary artisan prevails. Terms like “a” and “an” denote “at least one” unless context dictates otherwise. “Or” denotes “at least one of the items” without excluding a plurality, and “and” denotes “all of the items.”

The detailed description refers to accompanying drawings, using consistent reference numbers for similar elements. While many embodiments are described, modifications, adaptations, and other implementations are possible. Substitutions, additions, or modifications may be made to the elements illustrated, and methods may be modified by substituting, reordering, or adding stages. The detailed description does not limit the disclosure; the proper scope is defined by the claims. Headers are used for reference and are not limiting on the subject matter disclosed.

The present disclosure includes many aspects and features. While many relate to methods, systems, apparatuses, and devices for collision avoidance systems, embodiments are not limited to these contexts.

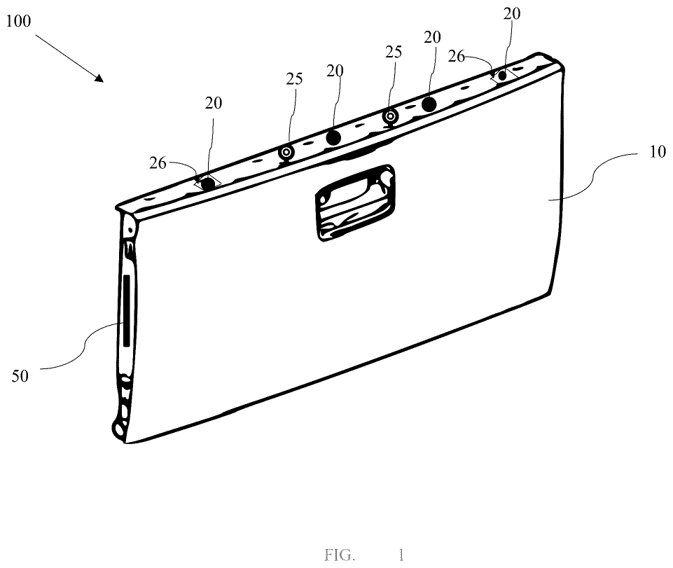

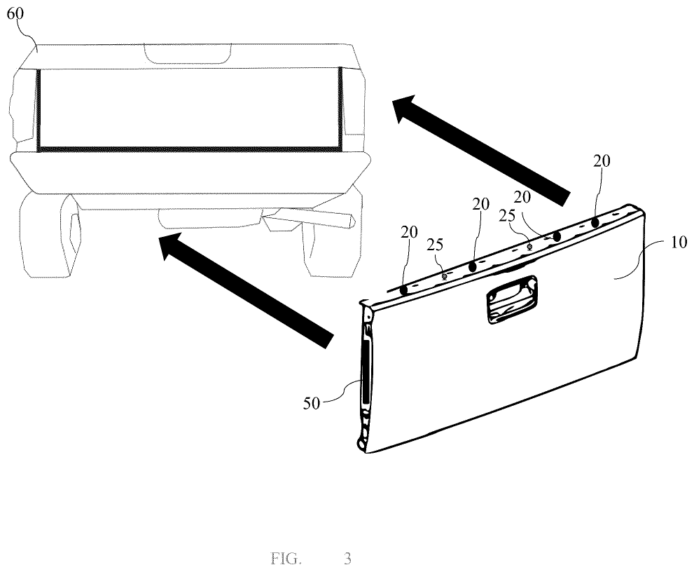

The present invention, as shown in FIGS. 1-3, provides a device 100 comprising a tailgate body 10, a sensor array 20, a camera system 25, and a control unit 30. These components work in unison to enhance the safety and functionality of a vehicle's tailgate, particularly when it is in an extended position. The sensors (sensor array) 20 and cameras (camera system) 25 can be mounted using brackets or adhesive materials designed to withstand environmental conditions and vibrations from vehicle movement.

### Tailgate Body 10

The tailgate body 10 may be configured in a rectangular shape or any other suitable geometric form that aligns with the specifications of the intended vehicle. It may be fabricated from steel or any analogous material typically employed in the construction of vehicle tailgates. In some embodiments, the tailgate body 10 may comprise one or more recessed regions 26 designed to accommodate sensors 20 and cameras 25.

### Sensor Array (Sensors) 20

The sensor array 20 comprises radar and ultrasonic sensors affixed to the tailgate body 10. These sensors 20 are capable of detecting oncoming obstacles by emitting waves that reflect off nearby objects. The sensors 20 alert the operator through audible warnings that vary in pitch and frequency as the detected object approaches.

In one embodiment, the sensors 20 are mounted on the top deck of the truck's (vehicle's) closed tailgate body 10. This configuration allows standard parking sensors and rear cross-traffic alert systems to function normally when the tailgate body 10 is closed. When the tailgate body 10 is extended (opened), the sensors 20 are positioned (activated) to emit radar waves effectively, maintaining collision avoidance capabilities. This can be configured by using the control unit 30.

### Camera System (Cameras) 25

In some embodiments, the device incorporates a camera system 25 within the tailgate-mounted sensors 20. This camera 25 provides the driver with a visual aid, further enhancing collision avoidance during reverse operations. The camera 25 can be connected to a display inside the vehicle, offering real-time video feedback to the driver.

### Control Unit 30

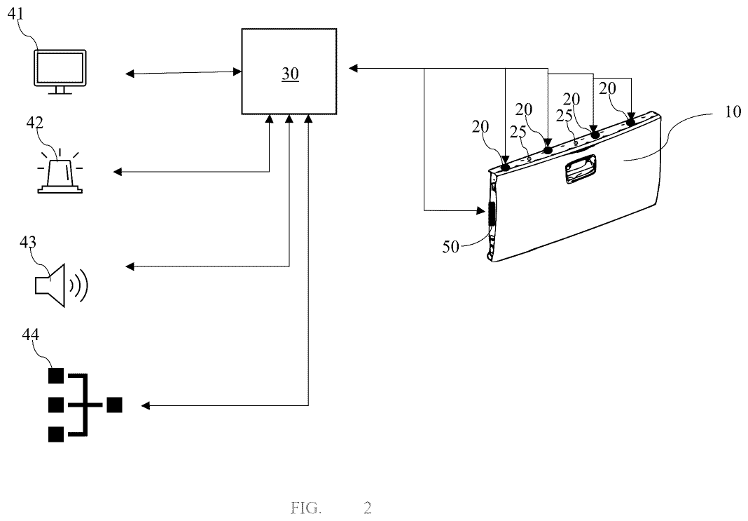

The control unit 30 is a central component that manages the operation of the sensors 20 and camera system 25. As shown in FIG. 2, it can be connected to notification lights 42, sound speakers 43, and a warning display 41, all of which can be configured by the user.

In some embodiments, the control unit 30 may include movement detectors 50 (movement sensors) to detect the opening and closing of the tailgate body 10, and is configured such that, when the tailgate body 10 is extended, the sensors 20 in the sensor array (attached to the top side of the tailgate body) are activated to emit radar waves. The movement detectors 50 may include sensors such as optical, infrared, radio wave, passive infrared (PIR), ultrasonic, microwave, tomographic, and combined sensors.

In a preferred embodiment, the control unit 30 supports both wireless and wired connections, allowing for flexible installation and integration with existing vehicle systems. The control unit can also interface with an automatic braking mechanism 44 to halt the vehicle 60 if the driver fails to respond promptly to warnings.

The components of the device 100 can be attached to the tailgate body 10 using various methods, such as adhesive mounts, screws, or brackets. In some embodiments, the sensors 20 and cameras 25 are detachable, allowing for easy maintenance or replacement. In some embodiments, as shown in FIG. 1, the tailgate body 10 may include recessed areas 26 to accommodate the sensors 20 and cameras 25, providing a streamlined appearance and protecting the components from damage.

The Extended Tailgate Collision Avoidance (ETCA) system (device 100) of the present invention ensures the continued operation of collision detection and prevention systems even when the tailgate (tailgate body 10) is extended. This enhances safety and reduces the likelihood of accidents during reverse driving with an overloaded truck bed. The ability to customize and configure the system (device 100) of the present invention according to user preferences further adds to its versatility and effectiveness.

Although the invention has been explained in relation to its preferred embodiment, it is to be understood that many other possible modifications and variations can be made without departing from the spirit and scope of the invention.

What is claimed is:

1. A device comprising:
a tailgate body;
a sensor array attached to the tailgate body,
a camera system attached to the tailgate body, and
a control unit connected to the sensor array and the camera system.

2. The device as claimed in claim 1, wherein the tailgate body includes one or more recessed areas.

3. The device as claimed in claim 2, wherein the sensor array comprises radar and ultrasonic sensors.

4. The device as claimed in claim 1, wherein the control unit includes movement detectors to detect the opening and closing of the tailgate body, and is configured such that, when the tailgate body is extended, the sensors are activated to emit radar waves.

5. The device as claimed in claim 2, wherein the camera is connected to a display inside a vehicle.

6. The device as claimed in claim 2, wherein the control unit is connected to notification lights.

7. The device as claimed in claim 2, wherein the control unit is connected to sound speakers.

8. The device as claimed in claim 1, wherein the control unit is connected to a warning display.

9. The device as claimed in claim 4, wherein the control unit is configured to interface with an automatic braking mechanism to halt the vehicle if the driver fails to respond promptly to warnings.

10. A device comprising:
A tailgate body having a top side, a right side, a left side, and a bottom side, wherein the top side is configured with one or more recessed areas that are equally spaced apart;
a sensor array attached to the tailgate body within the one or more recessed areas,
a camera system attached to the tailgate body, and
a control unit connected to the sensor array and the camera system.

11. The device as claimed in claim 10, wherein the sensor array comprises radar and ultrasonic sensors.

12. The device as claimed in claim 11, wherein the control unit is configured such that, when the tailgate body is extended, the sensors are activated to emit radar waves.

13. The device as claimed in claim 11, wherein the camera is connected to a display inside a vehicle.

14. A device comprising:
a tailgate body having a top side, a right side, a left side, and a bottom side,
wherein the top side is configured with one or more recessed areas that are equally spaced apart;
a sensor array attached to the tailgate body within the one or more recessed areas;
a camera system attached to the tailgate body within the one or more recessed areas; and
a control unit connected to the sensor array and the camera system, wherein the control unit is wirelessly connected to notification lights.

15. The device as claimed in claim 14, wherein the sensor array comprises radar and ultrasonic sensors.

16. The device as claimed in claim 15, wherein the control unit includes movement detectors to detect the opening and closing of the tailgate body, and is configured such that, when the tailgate body is extended, the sensors are activated to emit radar waves.

17. The device as claimed in claim 16, wherein the camera is connected to a display inside a vehicle.

18. The device as claimed in claim 14, wherein the control unit is connected to sound speakers.

19. The device as claimed in claim 14, wherein the control unit is connected to a warning display.

20. The device as claimed in claim 14, wherein the control unit is configured to interface with an automatic braking mechanism to halt the vehicle if the driver fails to respond promptly to warnings.
